(19) United States
(12) Patent Application Publication
(10) Pub. No.: US 2013/0226324 A1
(43) Pub. Date: Aug. 29, 2013

(54) AUDIO SCENE APPARATUSES AND METHODS

(71) Applicants: Miska Hannuksela, Tampere (FI); Pasi Ojala, Kirkkonummi (FI); Juha Ojanpera, Nokia (FI)

(72) Inventors: Miska Hannuksela, Tampere (FI); Pasi Ojala, Kirkkonummi (FI); Juha Ojanpera, Nokia (FI)

(73) Assignee: NOKIA CORPORATION, Espoo (FI)

(21) Appl. No.: 13/876,324

(22) PCT Filed: Sep. 27, 2010
(86) PCT No.: PCT/IB2010/054347

§ 371 Date: May 9, 2013

(51) Int. Cl. G06F 3/16

(52) U.S. Cl. CPC G06F 3/16
USPC 700/94

(57) ABSTRACT

Apparatus comprising at least one processor and at least one memory including computer code, the at least one memory and the computer code configured to with the at least one processor cause the apparatus to at least perform: generating a message comprising a first part for determining a sensory space associated with the apparatus; determining a capture control parameter dependent on a sensory space apparatus distribution; and capturing a signal based on the capture control parameter.

### FIELD OF THE APPLICATION

The present application relates to apparatus for the processing of audio and additionally video signals. The invention further relates to, but is not limited to, apparatus for processing audio and additionally video signals from mobile devices.

### SUMMARY OF THE APPLICATION

Viewing recorded or streamed audio-video or audio content is well known. Commercial broadcasters covering an event often have more than one recording device (video-camera/microphone) and a programme director will select a ‘mix’ where an output from a recording device or combination of recording devices is selected for transmission.

Multiple ‘feeds’ may be found in sharing services for video and audio signals (such as those employed by YouTube). Such systems, which are known and are widely used to share user generated content recorded and uploaded or up-streamed to a server and then downloaded or down-streamed to a viewing/listening user. Such systems rely on users recording and uploading or up-streaming a recording of an event using the recording facilities at hand to the user. This may typically be in the form of the camera and microphone arrangement of a mobile device such as a mobile phone.

Often the event is attended and recorded from more than one position by different recording users at the same time. The viewing/listening end user may then select one of the up-streamed or uploaded data to view or listen.

Where there is multiple user generated content for the same event it can be possible to generate a “three dimensional” rendering of the event by combining various different recordings from different users or improve upon user generated content from a single source, for example reducing background noise by mixing different users content to attempt to overcome local interference, or uploading errors.

There can be a problem in multiple recording systems where the recording devices are in close proximity and the same audio scene is recorded multiple times. This is generally due to recording devices not being aware of other devices recording the same audio scene. This can cause recording redundancy and inefficiencies to the overall end-to-end system in terms of required storage space at the device and server, battery life of devices, network bandwidth utilisation and other resources as multiple devices may be recording and encoding the same scene from approximately the same position and the same content recorded and uploaded to a central server multiple times.

Aspects of this application thus provide an audio scene capturing process whereby multiple devices can be present and recording the audio scene and whereby the server can further discover or detect audio scenes from the uploaded data.

There is provided according to the application an apparatus comprising at least one processor and at least one memory including computer code, the at least one memory and the computer code configured to with the at least one processor cause the apparatus to at least perform: generating a message comprising a first part for determining a sensory space associated with the apparatus; determining a capture control parameter dependent on a sensory space apparatus distribution; and capturing a signal based on the capture control parameter.

The message first part may comprise at least one of: a captured audio signal; an estimated location of the apparatus; and an estimated direction of the apparatus.

The capture control parameter may comprise at least one of: a capture time period; a capture frequency range; and a capture direction.

The apparatus may be further configured to perform determining the sensory space apparatus distribution.

Determining the sensory space apparatus distribution may cause the apparatus to further perform: determining whether at least one further apparatus is associated with the sensory space associated with the apparatus.

The apparatus may be further caused to perform receiving a further message comprising a first part for determining a sensory space associated with the at least one further apparatus.

The apparatus may be further caused to perform outputting the signal based on the capture control parameter.

The apparatus may be further caused to perform outputting the message comprising the first part for determining a sensory space associated with the apparatus to a further apparatus.

The apparatus may be further caused to perform receiving the sensory space apparatus distribution from a further apparatus in response to outputting the message comprising the first part for determining a sensory space associated with the apparatus to a further apparatus.

The signal may comprise at least one of: a captured audio signal; a captured image signal; and a captured video signal.

According to a second aspect of the application there is provided an apparatus comprising at least one processor and at least one memory including computer code, the at least one memory and the computer code configured to with the at least one processor cause the apparatus to at least perform: determining, for at least one sensory space, a sensory space apparatus distribution information; generating information on the at least one sensory space apparatus distribution for controlling the capture apparatus in the sensory space.

Determining the sensory space apparatus distribution information may cause the apparatus to further perform determining whether there is at least one apparatus configurable to capture at least one event in the at least one sensory space.

The apparatus may be further caused to perform outputting the information for controlling the capture apparatus in the sensory space to at least one capture apparatus in the sensory space.

The information for controlling the capture apparatus may be at least one of: time division multiplexing information; spatial division multiplexing information; and frequency division multiplexing information.

The apparatus may be further caused to perform combining at least two capture signal clips to produce a combined capture signal.

The apparatus may be further caused to perform receiving at least one capture clip from a further apparatus.

The combining at least two capture signal clips may cause the apparatus to perform filtering each capture signal clip and combining each filtered capture signal clip.

The information for controlling the capture apparatus in the sensory space may comprise a capture handover request.

Determining, for at least one sensory space, a sensory space apparatus distribution information may cause the apparatus to perform: determining whether at least one further apparatus is associated with the at least one sensory space.

Determining whether at least one further apparatus is associated with the at least one sensory space may cause the apparatus to perform: receiving at least one further apparatus message comprising a first part for determining a sensory space associated with the apparatus; and determining whether at least one further apparatus is associated with the at least one sensory space based on the at least one further apparatus message.

According to a third aspect of the application there is provided a method comprising: generating a message comprising a first part for determining a sensory space associated with the apparatus; determining a capture control parameter dependent on a sensory space apparatus distribution; and capturing a signal based on the capture control parameter.

The message first part may comprise at least one of: a captured audio signal; an estimated location of the apparatus; and an estimated direction of the apparatus.

The capture control parameter may comprise at least one of: a capture time period; a capture frequency range; and a capture direction.

The method may further comprise determining the sensory space apparatus distribution.

Determining the sensory space apparatus distribution may further comprise determining whether at least one further apparatus is associated with the sensory space associated with the apparatus.

The method may further comprise receiving a further message comprising a first part for determining a sensory space associated with the at least one further apparatus.

The method may further comprise outputting the signal based on the capture control parameter.

The method may further comprise outputting the message comprising the first part for determining a sensory space associated with the apparatus to a further apparatus.

The method may further comprise receiving the sensory space apparatus distribution from a further apparatus in response to outputting the message comprising the first part for determining a sensory space associated with the apparatus to a further apparatus.

The signal may comprise at least one of: a captured audio signal; a captured image signal; and a captured video signal.

According to a fourth aspect of the application there is provided a method comprising: determining, for at least one sensory space, a sensory space apparatus distribution information; generating information on the at least one sensory space apparatus distribution for controlling the capture apparatus in the sensory space.

Determining the sensory space apparatus distribution information may comprise determining whether there is at least one apparatus configurable to capture at least one event in the at least one sensory space.

The method may further comprise outputting the information for controlling the capture apparatus in the sensory space to at least one capture apparatus in the sensory space.

The information for controlling the capture apparatus may be at least one of: time division multiplexing information; spatial division multiplexing information; and frequency division multiplexing information.

The method may further comprise combining at least two capture signal clips to produce a combined capture signal.

The method may further comprise receiving at least one capture clip from a further apparatus.

Combining at least two capture signal clips may further comprise filtering each capture signal clip and combining each filtered capture signal clip.

The information for controlling the capture apparatus in the sensory space may comprise a capture handover request.

Determining, for at least one sensory space, a sensory space apparatus distribution information may comprise determining whether at least one further apparatus is associated with the at least one sensory space.

Determining whether at least one further apparatus is associated with the at least one sensory space may comprise: receiving at least one further apparatus message comprising a first part for determining a sensory space associated with the apparatus; and determining whether at least one further apparatus is associated with the at least one sensory space based on the at least one further apparatus message.

According to a fifth aspect of the application there is provided a computer-readable medium encoded with instructions that, when executed by a computer, perform: generating a message comprising a first part for determining a sensory space associated with the apparatus; determining a capture control parameter dependent on a sensory space apparatus distribution; and capturing a signal based on the capture control parameter.

According to a sixth aspect of the application there is provided a computer-readable medium encoded with instructions that, when executed by a computer, perform: determining, for at least one sensory space, a sensory space apparatus distribution information; generating information on the at least one sensory space apparatus distribution for controlling the capture apparatus in the sensory space.

According to a seventh aspect of the application there is provided an apparatus comprising: a message generator configured to generate a message comprising a first part for determining a sensory space associated with the apparatus; a recording controller configured to determine a capture control parameter dependent on a sensory space apparatus distribution; and a recorder configured to capture a signal based on the capture control parameter.

The message first part may comprise at least one of: a captured audio signal; an estimated location of the apparatus; and an estimated direction of the apparatus.

The capture control parameter may comprise at least one of: a capture time period; a capture frequency range; and a capture direction.

The apparatus may further comprise an apparatus distribution determiner configured to determine the sensory space apparatus distribution.

The apparatus distribution determiner may comprise an sensory space determiner configured to determine whether at least one further apparatus is associated with the sensory space associated with the apparatus.

The apparatus may further comprise a receiver configured to receive a further message comprising a first part for determining a sensory space associated with the at least one further apparatus.

The apparatus may further comprise a transmitter configured to output the signal based on the capture control parameter.

The transmitter may further be configured to output the message comprising the first part for determining a sensory space associated with the apparatus to a further apparatus.

The receiver may be configured to receive the sensory space apparatus distribution from a further apparatus in response to outputting the message comprising the first part for determining a sensory space associated with the apparatus to a further apparatus.

The signal may comprise at least one of: a captured audio signal; a captured image signal; and a captured video signal.

According to a eighth aspect of the application there is provided an apparatus comprising: an apparatus distribution determiner configured to determine, for at least one sensory space, apparatus distribution information; and a recording information generator configured to generate information on the at least one sensory space apparatus distribution for controlling the capture apparatus in the sensory space.

The recording information generator may comprise a recording task distribution determiner configured to determine whether there is at least one apparatus configurable to capture at least one event in the at least one sensory space.

The apparatus may further comprise a transmitter configured to output the information for controlling the capture apparatus in the sensory space to at least one capture apparatus in the sensory space.

The information for controlling the capture apparatus may be at least one of: time division multiplexing information; spatial division multiplexing information; and frequency division multiplexing information.

The apparatus may further comprise a clip combiner configured to combine at least two capture signal clips to produce a combined capture signal.

The apparatus may further comprise a receiver configured to receive at least one capture clip from a further apparatus.

The clip combiner may comprise a filter configured to filter each capture signal clip and a clip sample combiner configured to combine each filtered capture signal clip sample by sample.

The information for controlling the capture apparatus in the sensory space may comprise a capture handover request.

The apparatus distribution determiner may comprise: an apparatus association determiner configured to determine whether at least one further apparatus is associated with the at least one sensory space.

The apparatus association determiner may comprise: the receiver further configured to receive at least one further apparatus message comprising a first part for determining a sensory space associated with the apparatus; and further configured to determine whether at least one further apparatus is associated with the at least one sensory space based on the at least one further apparatus message.

According to a ninth aspect of the application there is provided an apparatus comprising: means for generating a message comprising a first part for determining a sensory space associated with the apparatus; means for determining a capture control parameter dependent on a sensory space apparatus distribution; and means for capturing a signal based on the capture control parameter.

The message first part may comprise at least one of: a captured audio signal; an estimated location of the apparatus; and an estimated direction of the apparatus.

The capture control parameter may comprise at least one of: a capture time period; a capture frequency range; and a capture direction.

The apparatus may further comprise means for determining the sensory space apparatus distribution.

The means for determining the sensory space apparatus distribution may further comprise means for determining whether at least one further apparatus is associated with the sensory space associated with the apparatus.

The apparatus may further comprise means for receiving a further message comprising a first part for determining a sensory space associated with the at least one further apparatus.

The apparatus may further comprise means for outputting the signal based on the capture control parameter.

The apparatus may further comprise means for outputting the message comprising the first part for determining a sensory space associated with the apparatus to a further apparatus.

The apparatus may further comprise means for receiving the sensory space apparatus distribution from a further apparatus in response to outputting the message comprising the first part for determining a sensory space associated with the apparatus to a further apparatus.

The signal may comprise at least one of: a captured audio signal; a captured image signal; and a captured video signal.

According to a tenth aspect of the application there is provided apparatus comprising: means for determining, for at least one sensory space, a sensory space apparatus distribution information; and means for generating information on the at least one sensory space apparatus distribution for controlling the capture apparatus in the sensory space.

The means for determining the sensory space apparatus distribution information may comprise means for determining whether there is at least one apparatus configurable to capture at least one event in the at least one sensory space.

The apparatus may further comprise means for outputting the information for controlling the capture apparatus in the sensory space to at least one capture apparatus in the sensory space.

The information for controlling the capture apparatus may be at least one of: time division multiplexing information; spatial division multiplexing information; and frequency division multiplexing information.

The apparatus may further comprise means for combining at least two capture signal clips to produce a combined capture signal.

The apparatus may further comprise means for receiving at least one capture clip from a further apparatus.

The means for combining at least two capture signal clips may further comprise means for filtering each capture signal clip and wherein the means for combining may combine each filtered capture signal clip.

The information for controlling the capture apparatus in the sensory space may comprise a capture handover request.

The means for determining, for at least one sensory space, a sensory space apparatus distribution information may comprise means for determining whether at least one further apparatus is associated with the at least one sensory space.

The means for determining whether at least one further apparatus is associated with the at least one sensory space may comprise: means for receiving at least one further apparatus message comprising a first part for determining a sensory space associated with the apparatus; and means for determining whether at least one further apparatus is associated with the at least one sensory space based on the at least one further apparatus message.

An electronic device may comprise apparatus as described above.

A chipset may comprise apparatus as described above.

Embodiments of the present invention aim to address the above problems.

### SUMMARY OF FIGURES

For better understanding of the present application, reference will now be made by way of example to the accompanying drawings in which:

FIG. 1a shows schematically a multi-user viewpoint media sharing system which may incorporate embodiments of the application;

FIG. 1b shows a flow diagram showing the overview of the operation of the multi-user viewpoint media sharing system incorporating embodiments of the application;

FIG. 2a shows schematically an audio capture apparatus within a multi-user viewpoint media sharing system according to some embodiments of the application;

FIG. 2b shows schematically an audio scene server within a multi-user viewpoint media sharing system according to some embodiments of the application;

FIG. 2c shows schematically a listening apparatus within a multi-user viewpoint media sharing system according to some embodiments of the application;

FIG. 3 shows schematically the audio capture apparatus in further detail according to some embodiments of the application;

FIG. 4 shows schematically the audio scene processor in further detail according to some embodiments of the application;

FIG. 5 shows the operation of the audio capture apparatus shown in FIG. 3 according to some embodiments of the application;

FIG. 6 shows the operation of the audio scene processor as shown in FIG. 4 according to some embodiments of the application;

FIG. 7 shows a timing view of the operation of audio capture apparatus according to some embodiments of the application;

FIG. 8 shows a schematic view of a grid of audio capture apparatus according to some embodiments of the application;

FIG. 9 shows the a schematic view of a generator as shown in FIG. 4 in according to some embodiments of the application;

FIG. 10 shows the operation of the generator according to some embodiments in further detail; and

FIG. 11 shows one method of combining audio clips according to some embodiments of the application.

### DESCRIPTION OF EMBODIMENTS

The following describes in further detail suitable apparatus and possible mechanisms for the provision of effective synchronisation for audio. In the following examples audio signals and audio capture uploading and downloading is described. However it would be appreciated that in some embodiments the audio signal/audio capture, uploading and downloading is one part of an audio-video system.

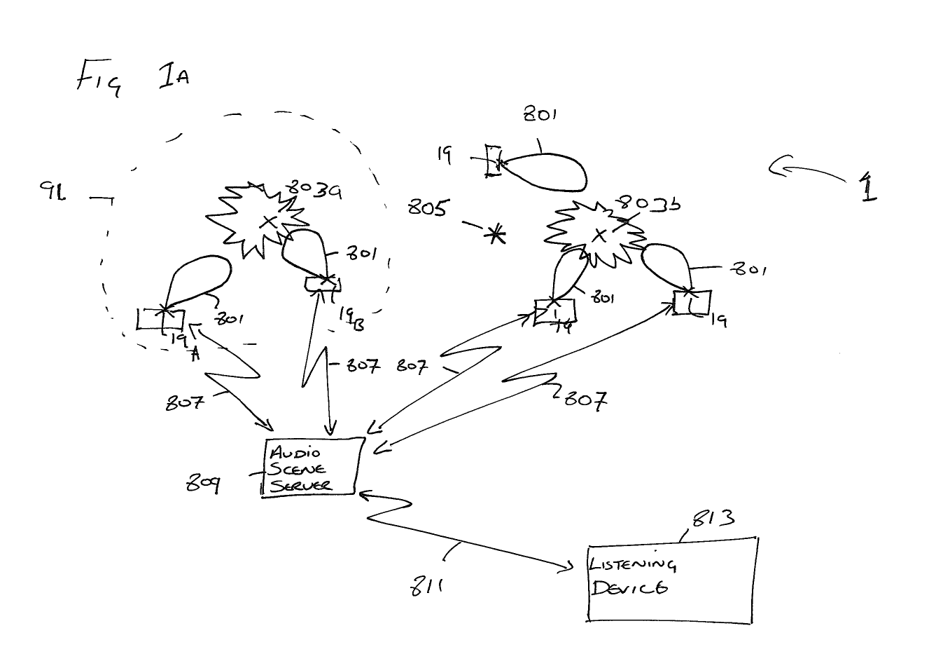

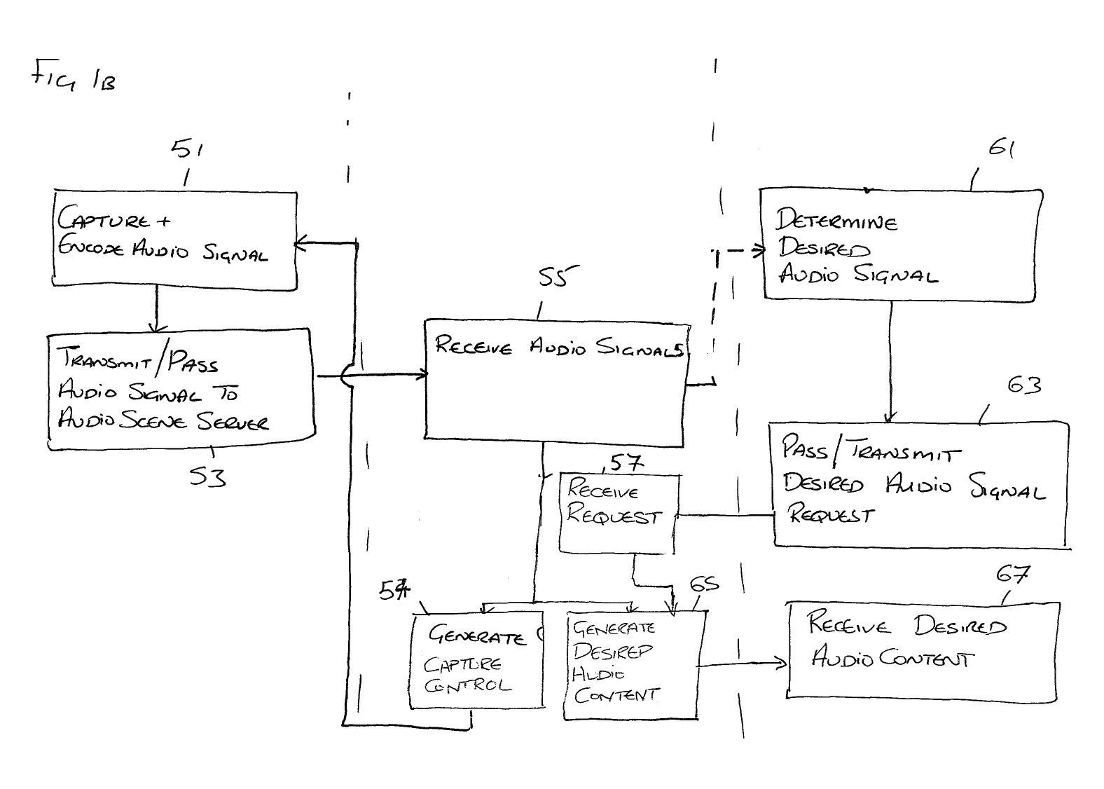

With respect to FIGS. 1a and 1b an overview of a suitable system within which embodiments of the application can be employed is shown. The system is shown operating within an audio space 1 which can have located within it at least one audio capture device 19 or apparatus to record or capture suitable audio events 803. The audio capture apparatus 19 shown in FIG. 1 are represented with a directional capture or recording profile shown by a beam forming pattern 801 associated with each audio capture apparatus 19. The audio capture apparatus 19 however in some embodiments can be configured to have an omnidirectional beam or different profile to that shown in FIG. 1. In some embodiments the audio capture apparatus 19 can be configured to have multiple audio capture components each suitable for independently capturing or recording an audio source. In such embodiments the audio capture apparatus 19 can be considered to comprise multiple audio capture apparatus 19 components each functioning as separate audio capture apparatus 19.

The audio capture apparatus 19 in FIG. 1a are shown such that some of the audio capture apparatus 19 are located near to an audio scene or activity source 803 and therefore capable of capturing or recording the audio scene or activity source 803 in the audio space 1. The audio activity or scene 803 can be a music event such as a concert or the audio component of a news worthy event.

The audio capture apparatus 19 in some embodiments can further encode the audio signal to compress the audio signal in a known way in order to reduce the bandwidth required in uploading the audio signal or storing the audio signal.

The operation of capturing and encoding the audio signal is shown in FIG. 1b by step 51.

The audio capture apparatus 19 can in some embodiments transmit or pass the audio signal via a transmission channel 807 to an audio scene server 809. The transmission channel 807 can in some embodiments be a wireless transmission channel or a wired transmission channel. Furthermore, in some embodiments the audio capture apparatus 19 and audio scene server 809 can be implemented within the same physical apparatus body, in which embodiments the audio capture apparatus 19 passes the audio signal internally to the audio scene server 809.

The transmission or passing the audio signal to the audio scene server is shown in FIG. 1b by step 53. The audio capture apparatus 19 in some embodiments can be configured to estimate and further upload to the audio scene server 809 via the transmission channel 807 or a different transmission channel not shown an estimation of the location and/or the direction of the audio capture apparatus 19. The location information can be obtained, for example, in some embodiments using satellite positioning estimation such as GPS (Global Positioning Satellite) estimation, by radio frequency triangulation with reference to known beacon locations for example by cellular communications estimation, a combination of method such as assisted GPS estimation, or any other suitable location estimation method. Furthermore the direction or orientation of the audio capture apparatus 19 can be estimated for example using a digital compass, gyroscope or by calculating the difference between two location estimations.

In some embodiments as described herein, the audio capture apparatus 19 can be configured to capture or record more than one audio signal. For example, in some embodiments the audio capture apparatus 19 can comprise multiple microphones each configured to capture the audio signal from a different direction. In such embodiments, the audio capture apparatus 19 can supply directional information for each captured signal.

In some embodiments, the audio scene system comprises at least one listening device 813. Although only one listening device 813 is shown in FIG. 1a, it would be appreciated that a system may be linked to many listening devices where each listening device is capable of selecting different audio signals. In some embodiments, the listening device 813 can prior to, or during, downloading select a specific ‘listening point’. In other words, the listening device 813 can in such embodiments select a position such as indicated in FIG. 1a by the selected listening point indication 805.

The operation of determining a desired audio signal to be listened to, or ‘listening point’ is shown in FIG. 1b by step 61.

The listening device 813 is some embodiments can be coupled to the audio scene server 809 via a further communication or transmission channel 811. The further transmission channel 811 can in some embodiments be a wireless communications channel, or a wired communications channel. Furthermore, in some embodiments the listening device 813 and audio scene server 809 can be implemented within a single apparatus and as such the coupling between the listening device 813 and audio scene service 809 is an internal coupling.

In such embodiments, the listening device 813 can communicate the desired audio signal request to the audio scene server 809 via the further transmission channel 811.

The operation of passing the desired audio signal request is shown in FIG. 1b by step 63.

In some embodiments the audio scene system comprises an audio scene server 809. The audio scene server 809 as discussed herein can be configured to receive from each audio capture apparatus 19 an audio signal and in some further embodiments an estimation of the associated location and/or direction of the audio capture apparatus 19.

The operation of receiving the audio signals is shown in FIG. 1b by step 55.

The audio scene server 809 can be configured in such embodiments to pass to the listening device 813 via the server communication or transmission channel 811. The location and/or direction of the audio capture apparatus 19 associated with the audio signal from which the listening device 813 can select one audio signal. This passing of information about the audio capture apparatus 19 between the audio scene server 809 and listening device 813 is shown in FIG. 1b by the dotted line. The listening device 813 in some embodiments can be configured to select from a list of audio capture apparatus an audio signal from an audio capture apparatus.

The audio scene server 809 can in some embodiments be configured to furthermore generate capture control signals for passing back to the audio capture control apparatus 19 based on the received audio (and location and/or direction) signals received from the audio capture apparatus and the desired audio information (the location and/or direction of an audio capture apparatus or a desired location and/or direction of an audio capture apparatus) from the listening device 813.

The operation of generating capture control is shown in FIG. 1b by step 57.

Furthermore the audio scene server 809, having received the audio signals from the audio capture apparatus 19 and a request containing desired audio signal information from the listening device 813, can be configured to generate desired audio content by processing the received audio signals.

The audio scene server 809 can as discussed herein receive each uploaded audio signal and the location and/or direction associated with each audio signal. In some embodiments, the audio scene server 809 can furthermore generate the desired audio content by selecting one of the audio signals or generate a down-mixed signal or generate a combination of signals (for example stereo signal from two audio signals) from a composite of audio signals uploaded from various audio capture apparatus 19.

The operation of generating the desired audio content is shown FIG. 1b by the step 165.

The listening device 813 can be configured to receive the generated audio content.

The operation of receiving of the desired audio content is shown in FIG. 1b by the step 67.

In some further embodiments the listening device 813 can be configured to select or determine other aspects of the desired audio signal, for example, signal quality, number of channels of audio desired etc. In some embodiments the audio scene server 807 can be configured to provide in some embodiment a set of downlink signals which correspond to listening points neighbouring the desired location/direction and the listening device 813 can select the audio signal desired from this set of downlink signals.

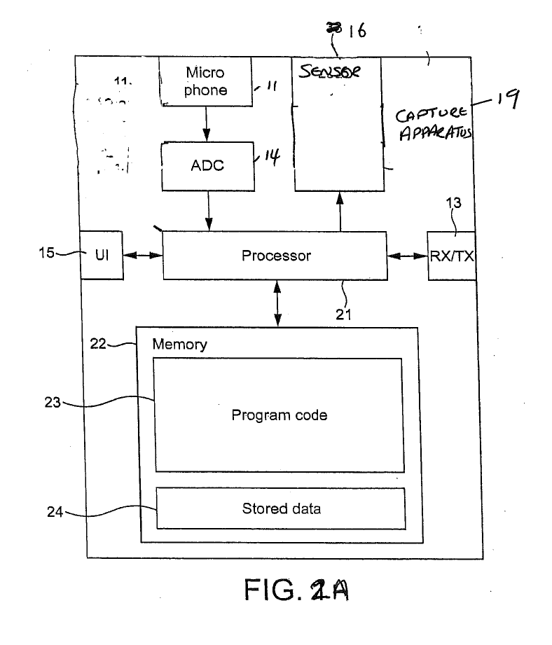

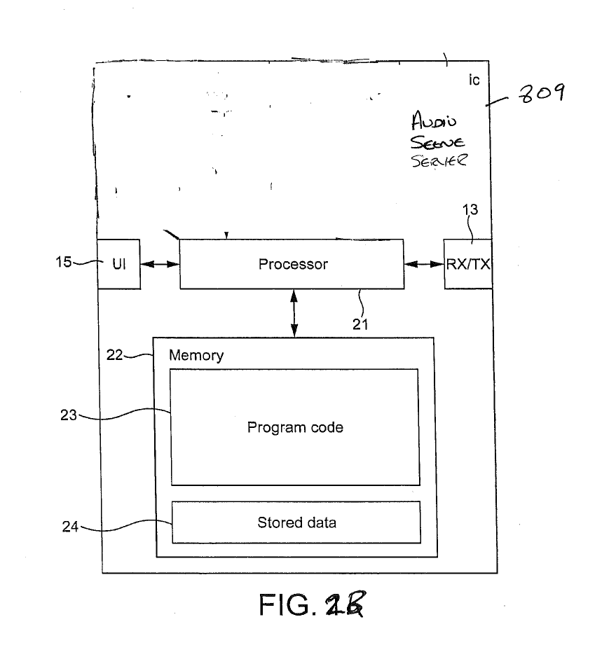

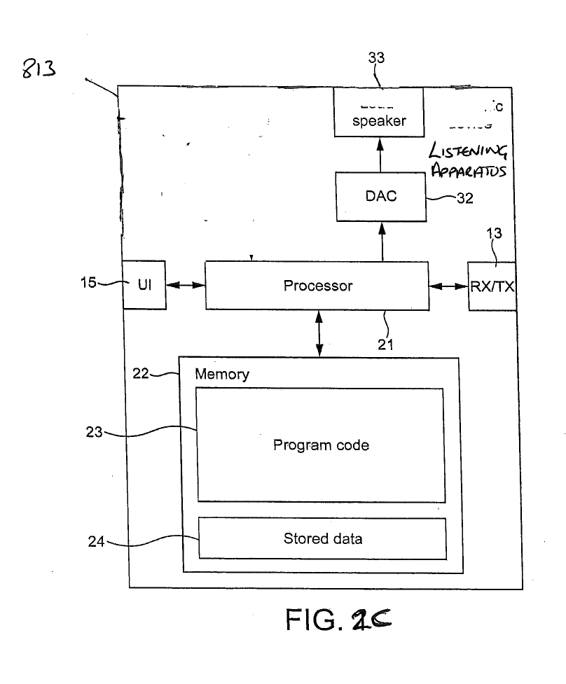

In this regard, reference is made to FIGS. 2a, 2b and 2c which show schematic block diagrams of exemplary apparatus for the audio capture apparatus 19, audio scene server 809, and the listening apparatus 813 respectively. Where in the following schematic block diagrams a similar reference value is used it is indicative that the component used is similar or the same.

The audio capture apparatus 19 can for example be a mobile terminal or user equipment of a wireless communication system. In some embodiments the audio capture apparatus can be an audio player or audio recorder, such as an MP3 player, a media recorder/player (also known as an MP4), or any suitable portable device suitable for recording audio or audio/video for example a camcorder.

The audio capture apparatus 19 can in some embodiments employ an audio sub-system. The audio sub-system can in some embodiments comprise a microphone or array of microphones 11 for audio signal capture. In some embodiments, the microphone or array of microphones can be a solid state microphone, in other words capable of capturing audio signals and outputting a suitable digital formal signal. In some other embodiments the microphone or array of microphones 11 can incorporate any suitable microphone or audio capture means, for example, a condenser microphone, a capacitor microphone, an electrostatic microphone, and electro-condenser microphone, a dynamic microphone, a ribbon microphone, a carbon microphone, a piezoelectric microphone or a micro-electrical-mechanical system (MEMS) microphone. The microphone 11 or array of microphones can in some embodiments output an audio captured signal to an analogue-to-digital converter (ADC) 14.

In some embodiments the audio sub-system can comprise an analogue-to-digital converter (ADC) 14 configured to receive the analogue audio signal from the microphone 11 and output the audio captured signal in a suitable digital form. The analogue-to-digital converter 14 can be any suitable analogue-to-digital conversion or processing means.

In some embodiments, the apparatus incorporates a processor 21. The processor 21 is coupled to the audio sub-system, for example the analogue-to-digital converter 14 to receive digital signals representing audio signals from the microphone. The processor 21 can in some embodiments be further configured to execute various program codes. The implemented program codes can for example be audio encoding code or routines.

In some embodiments, the apparatus can further incorporate a memory 22. The memory in some embodiments is coupled to the processor 21. The memory 22 can be implemented as any suitable storage means, for example random access memory (RAM), read-only memory (ROM) or electronically programmable memory. In some embodiments, the memory 22 can comprise a program code section 23 for storing program codes implementable on the processor 21. Furthermore in some embodiments, the memory can further comprise a stored data section 24 for storing data, for example data which has been encoded in accordance with the application or data to be encoded via the application embodiments as described herein. The implemented program code stored within the program code section 23, and the data stored within the stored data section 24 can be retrieved in some embodiments by the processor 21 whenever needed via a memory-processor coupling.

In some further embodiments, the audio capture apparatus 19 can comprise a user interface 15. The user interface 15 can in some embodiments be coupled to the processor 21. In some embodiments, the processor 21 can control the operation of the user interface 15 and receive input from the user interface 15. In some embodiments, the user interface 15 can enable a user to input commands to the audio capture apparatus 19, for example, via a keypad, and/or to obtain information from the audio capture apparatus 19, for example via a display which is part of the user interface 15. The user interface 15 can in some embodiments be implemented as a touch-screen or a touch-interface and be configured to both enable information to be entered to the audio capture apparatus 19 and to further display information to the user from the audio capture apparatus 19.

In some embodiments the audio capture apparatus 19 can further comprise a transceiver 13. The transceiver 13 in such embodiments can be coupled to the processor 21 and be configured to enable communication with further or other apparatus or electronic devices. In some embodiments, the transceiver is configured to communicate to the other apparatus or further electronic devices via a wireless communications network. The transceiver 13 or suitable transceiver or transmitter and/or receiver means can in some embodiments be configured to communicate with other electronic devices or apparatus via a wire or wired coupling.

The coupling, as shown in FIG. 1a, can be the transmission channel 807 (thus coupling the audio capture apparatus 19 to the audio scene server 809). The transceiver 13 can communicate with other devices or apparatus by any suitable known communication protocol. For example, in some embodiments the transceiver or transceiver means 13 can implement a suitable universal mobile telecommunication system (UMTS) protocol, a wireless local area network (WLAN) protocol such as for example, IEEE 802.x, a suitable short range radio frequency communication protocol such as Bluetooth, infrared data communications pathway such as (IRDA), or a wire coupling protocol such as universal serial bus (USB), firewire, or any suitable wire coupling protocol.

In some embodiments, the audio capture apparatus 19 further employs a sensor 16. In such embodiments the sensor 16 can comprise a location (or position) estimation sensor. For example, in some embodiments the sensor 16 can implement a satellite receiver such as a global positioning system (GPS) GLONASS or Galileo receiver. In some embodiments the sensor can be a cellular ID estimator or an assisted global positioning system (a-GPS) system.

In some embodiments, the sensor 16 can comprise a direction (or orientation) sensor such as an electronic compass, accelerometer, gyroscope or in some embodiments a positioning estimate based orientation estimation (for example to estimate a direction of the sensor 16 by calculating the difference between two location estimates).

With respect to FIG. 2b, a schematic view of the audio scene server 809 is shown. The audio scene server 809 can in some embodiments comprise a processor 21 coupled to a user interface 15, a transceiver 13 and memory 22.

The implemented program codes can for example be audio processing code routines as described herein.

The transceiver 13 can be configured in some embodiments to be suitable for communicating via the transmission channel 807 with the audio capture apparatus 19 and furthermore suitable for communicating via the further transmission channel 811 with the listening device 813. As described herein, the transceiver 13 can communicate with these further devices using any suitable known communication protocol.

The listening device 813 (or listening apparatus) shown with respect to FIG. 2c differs from the audio capture apparatus 19 in that the audio sub-system in some embodiments comprises a digital-to-analogue converter 32 for converting digital audio signals from the processor 21 into a suitable analogue format. The digital-to-analogue converter DAC or signal processing means 32 can in some embodiments be any suitable DAC technology.

Furthermore, the listening apparatus 813 audio sub-system furthermore can comprise a speaker 33. The speaker 33 can in some embodiments receive the output from the digital-to-analogue converter 32 and present the analogue audio signal to the user. In some embodiments, the speaker 33 can be representative of a headset, for example a set of headphones or cordless headphones.

The listening apparatus 813 can in some embodiments be implemented by a mobile terminal or a user equipment of a wireless communications system and audio player, a media player or any suitable portable device configured to present an audio signal to a user.

Furthermore it would be understood that in some embodiments the audio capture apparatus 19 can be configured to have the capability of implementing listening device 813 functionality and vice versa. In other words, a capture apparatus 19, or similarly a listening device 813 can employ an audio sub-system comprising, microphones, ADC, DAC and loudspeaker output components.

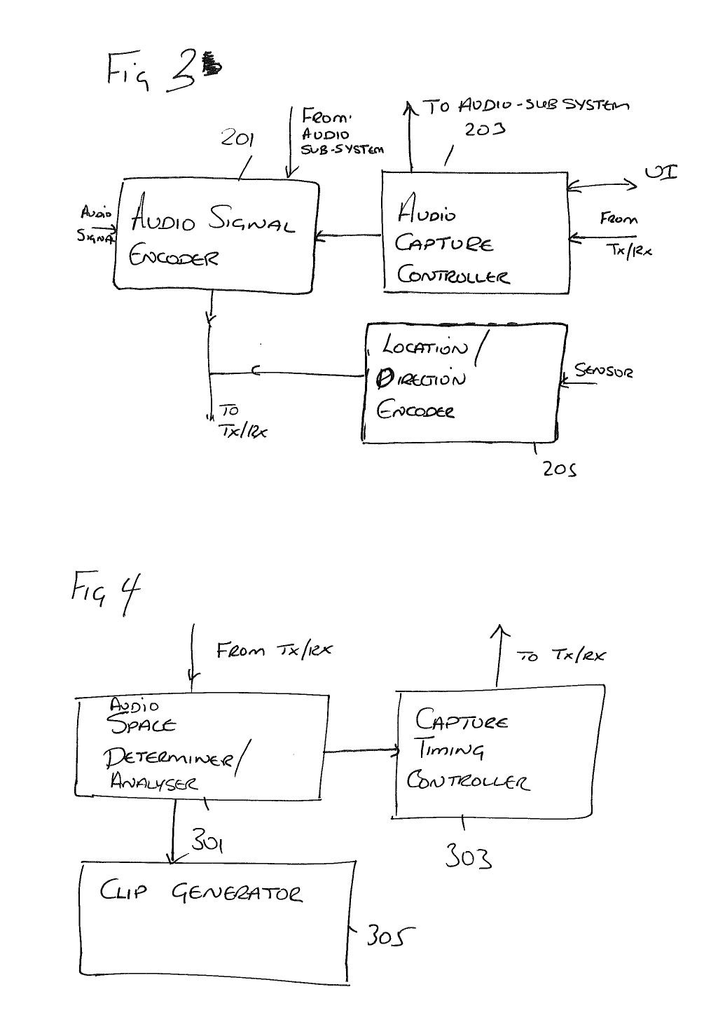

With respect of FIG. 3 the audio capture apparatus 19 is shown in further detail. Furthermore with respect to FIG. 5 the operation of the audio capture apparatus 19 according to some embodiments of the application are further described.

In some embodiments the audio capture apparatus 19 is configured to operate an audio capture controller 203. The audio capture controller 203 or suitable controlling means is configured to control the operation of the audio scene capture operation. The audio capture controller 203 in some embodiments is configured to determine whether to provide audio capture. For example the audio capture controller in some embodiments can be configured to receive an input from the user interface 15 for initialising the recording or capture of the audio event surrounding the apparatus. In some other embodiments, the audio capture controller 203 can initialise recording or capture after receiving a capture request message or indicator from the transceiver 13. The initialisation of capture or recording can for example be the powering up of the audio subsystem (the microphone and ADC), controlling the audio sub-system to capture from a determined direction or sending information to the user interface 15 displaying the direction in which the audio sub-system is to be directed to capture audio signals.

The audio capture controller 203 in some embodiments is configured to further control the audio signal encoder 201, for example to control the encoding rate or encoding algorithm selection.

The operation of initialising the audio capture operation is shown in FIG. 5 by step 401.

The audio signal encoder 201 is configured in some embodiments to receive the audio signals from the audio sub-system (the analogue-to-digital converter from the microphone or microphone array) and encode the audio signal into a suitable form for passing via the transceiver to the audio scene server 809. The audio signal encoder 201 can be configured to encode the audio signal in any suitable encoding form. For example in some embodiments the audio signal encoder can encode the audio signal using a high quality high-bit rate encoding process. Examples of high quality encoding can for example but not limited to coding schemes such as MP3, AAC, EAAC+, AMR-WV+, ITU G.718 and its annexes. For example, in some embodiments the audio signal encoder 201 can be configured to record and encode at 128 kbit/s using an AAC encoding operation. The encoded audio signal can be passed to the transceiver 13 to be passed to the audio scene server.

The operation of encoding the audio signal is shown in FIG. 5 by step 403.

In some embodiments the audio capture apparatus 19 further comprises a location/direction encoder configured to receive inputs from the sensor 16, such as estimated location and direction and encode the location or direction estimation in a form suitable to be output to the audio scene server 809. The location/direction encoder 205 can for example, receive the GPS estimation of the direction and location of the audio capture apparatus (and in some embodiments further information regarding the direction or orientation of the audio sub-system such as the profile of the microphone array) and encode it into a suitable form (for example using longitude and latitude values for location and direction in degrees). The location/direction encoded information can then be in some embodiments also passed to the audio scene server 809.

In some embodiments, the audio capture apparatus 19 can generate further information or notifications and pass these to the audio scene server 809. The information can be considered to be a fingerprint of the sensory space as captured by the device. The fingerprint can for example comprise information characterising the sensory space such as the estimated location of the audio capture apparatus 19, and other sensory information such as ambient lighting, temperature, acoustical characteristics such reverberation and metrics such as the duration and number of detected audio instants or events within a given time frame.

Therefore in summary at least one embodiment can comprise means for generating a message comprising a first part for determining a sensory space associated with the apparatus.

The message first part can in some embodiments be at least one of: a captured audio signal; an estimated location of the apparatus; and an estimated direction of the apparatus.

The capture control parameter may in such embodiments comprise at least one of: a capture time period; a capture frequency range; and a capture direction.

The passing of the audio signal (and in some embodiments the location/direction encoded information) is shown in FIG. 5 by step 405.

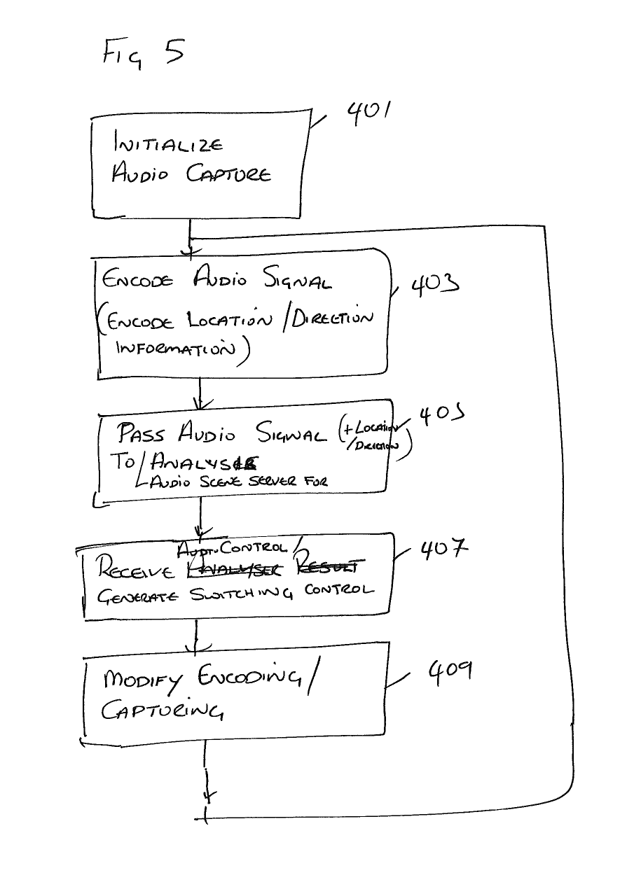

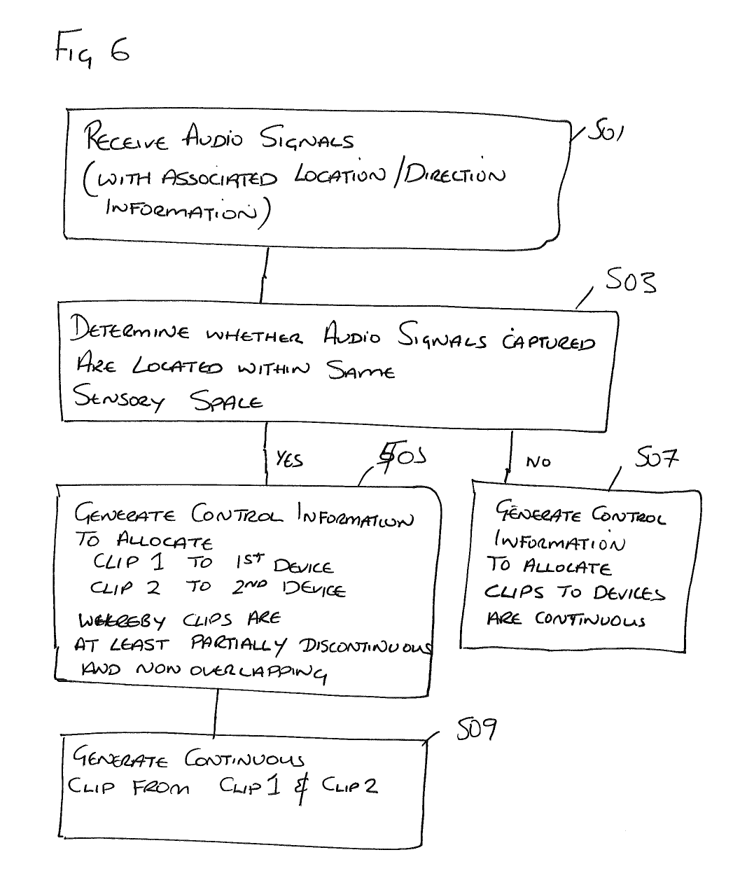

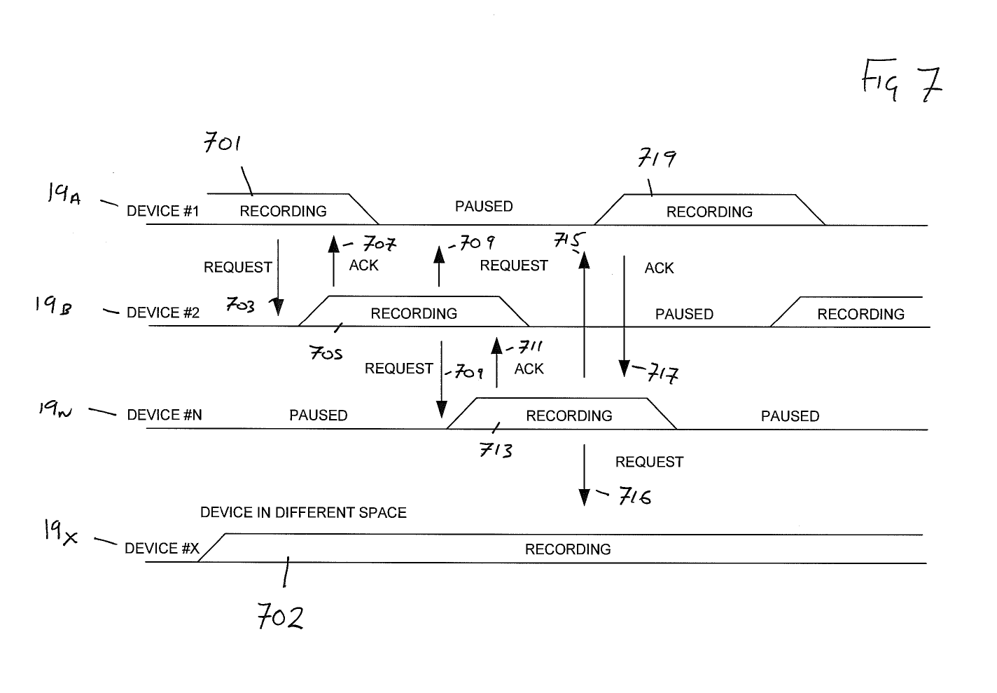

With respect to FIG. 4 and FIG. 6, the operation of the audio scene server 809 is shown in further detail. The audio scene server 809 in some embodiments can comprise an audio space determiner/analyser. The audio space determiner/analyser 301 is configured to receive at least one audio signal from the audio capture apparatus 19. In some embodiments the audio space determiner/analyser 301 is configured to group or order the audio signals received from the audio capture apparatus into shared audio space sets. The idea of shared audio space is that each of the audio capture apparatus operating within a shared audio space is configured to capture an audio event. For example, as shown in FIG. 1 there are two separate shared audio spaces each centred about the audio sources 803a and 803b.

Therefore in summary at least one embodiment can comprise means for determining the sensory space apparatus distribution.

In some embodiments the means for determining the sensory space apparatus distribution can further comprise means for determining whether at least one further apparatus is associated with the sensory space associated with the apparatus.

The operation of receiving the audio signals (with in some embodiments associated location/direction information) is shown in FIG. 6 by step 501.

The preliminary condition for the audio space determiner 301 determining that at least two audio signals are in a shared audio space is whether the audio capture apparatus are sensing the same space and same target. In other words determining whether the audio capture apparatus 19 are capturing the same content. The audio space determiner 301 can implement at least one of the following methods for determining that the devices are in the same shared audio space.

In some embodiments the audio space determiner 301 can be configured to receive the associated location/direction information from the audio capture apparatus 19 associated with the audio signals. In such embodiments the audio space determiner 301 can be configured to group each of the audio signals by clustering the location/direction information. Any suitable clustering algorithm can be used. For example in one such embodiment the audio space determiner 301 selects a first audio signal with associated location/direction estimates and selects other audio signals which have associated location/direction estimates within a determined error threshold from the first audio signal location/direction value.

The space determiner/analyser 301 can in some embodiments use information such as the originating audio capture apparatus cell identification value (Cell ID) to determine an approximate location of the audio capture apparatus using triangulation measurements. Similarly, wireless local area access points or access points or base stations of any other wireless networks can be used similarly to provide an approximate location estimate of an audio capture apparatus.

In some further embodiments the audio space determiner/analyser 301 can be configured to determine whether or not two audio signals are within a shared audio space based on characteristics or metrics from other sensory information. For example, in some embodiments the ambient lighting provided by a further sensor such as a camera light reading associated with each audio signal audio capture apparatus can compared. In some embodiments the audio space determiner/analyser 301 could use any images also captured by the capture apparatus 19 associated with the audio signals and compare these images to determine whether the audio capture apparatus 19 are close enough to capture the same event.

In some embodiments the audio space determiner 301 can be configured to determine whether or not two or more audio capture apparatus are located within the same sensory space by using known visual landmarks. The sensory space location can be estimated by for example detecting objects from a camera image from the sensors and using additional compass information. In some further embodiments, the known landmarks can emit visual beacon audio signals which are detected and supplied to the audio space determiner 301. For example, in a manner similar to marine navigation a beacon can be configured to emit visual signals with different pulses or signal codes in different directions. The direction of arrival from the beacon can therefore be determined.

Therefore in summary at least one embodiment can comprise means for determining, for at least one sensory space, a sensory space apparatus distribution information.

In some further embodiments the audio space determiner 301 can determine whether or not at least two audio capture apparatus are within the same sensory space by using visual image information from the audio capture device. For example in some embodiments, the audio space determiner can generate a three dimensional model of the environment within which the audio capture apparatus can be placed by using captured images and extracting and merging recognisable features in such images. The location and direction of the audio capture apparatus within the generated three-dimensional model can then be estimated in such embodiments by matching several feature points relative to the respective feature point of the three-dimensional model.

In some embodiments these visual based location estimation methods can be used to refine an initial rough estimate of the location by a satellite or cellular method.

In some further embodiments other sensed metrics or characteristics can be temperature. In such embodiments the audio space determiner/analyser 301 can group audio signals according to the associated audio capture apparatus 19 temperature.

In some further embodiments the audio signals can themselves be used to determine whether they are within the same shared audio space. In some such embodiments the audio space determiner can be configured to group the audio signals according to acoustical characteristics within the audio signals. For example in some embodiments the audio space determiner can be configured to group the audio signals based on at least one of the reverberation constant of the audio signal, the audio signal correlation, and the duration and number of ‘instants’ in other words detected elements within a given time frame.

In some embodiments the audio space determiner/analyser 301 can employ more than of these determination operations to determine whether or not the audio signals are within the same audio space. For example, in some embodiments a first ‘coarse’ clustering operation can be carried out using location/direction estimates and a second ‘fine’ clustering operation can be performed using an audio characteristic to verify the positioning information.

In some embodiments the audio space determiner 301 compares the “fingerprint” sent by audio capture apparatus to determine whether any other audio capture apparatus has similar “fingerprint” values and thus determine whether or not the audio capture apparatus are within the same sensory space.

In some further embodiments, the audio capture apparatus 19 themselves can assist in generating a distributed sensory space awareness by sending information through a local broadcast channel, such as a broadcast transmission and other an ad hoc WLAN channel or a multicast channel. In such embodiments each audio capture apparatus can be configured to output messages to other audio capture apparatus within a particular space. In some further embodiments, the audio capture apparatus 19 can send or pass a notification to further apparatus using a short range or proximity communication such as a wireless Bluetooth communication. In such embodiments the notification can comprise the “fingerprint” of the sensory space determined by the audio capture apparatus 19. Each audio capture apparatus 19 receiving the notification can be configured to record a fingerprint of its own sensory space and based on the similarity between the “fingerprints” determine whether or not the detected audio capture apparatus is within the same sensory or audio space.

In some such embodiments, the audio capture apparatus 19 can generate and pass to the audio space determiner 301 information indicating which other audio capture apparatus the audio capture apparatus 19 has determined is within its sensory or audio space.

Furthermore in some embodiments, the audio capture apparatus 19 can assist in the determination of audio spaces by emitting a characteristic signal such as for example an ultrasound signal of a particular form with a device specific identity code within a predefined frequency range. In such embodiments other audio capture apparatus can receive the predefined frequency range of the particular signal type and where the particular waveform has been detected, the other audio capture apparatus 19 determines that the first signal audio capture apparatus is within the same sensory or audio space and can generate a message to be passed to the audio scene server 809 indicating which audio capture apparatus the other audio capture apparatus determines is within its own sensory space region.

In the following examples, the audio scene server 809 is configured to determine whether or not audio signal captured are located within the same sensory space.

The operation of determining audio signals from audio capture apparatus are located within the same sensory space is shown in FIG. 6 by step 503.

The audio space determiner 301 can in some embodiments be coupled to a capture time controller 303 and pass information regarding to which devices or apparatus are within the same sensory space to the capture timing controller 303 and to the generator 305.

In some embodiments, the audio scene server 809 comprises a capture timing controller 303. The capture timing controller 303 in some embodiments is configured to, based on knowledge of which audio capture apparatus are in which audio space control audio capture apparatus within an shared audio space to supply audio signals to the audio scene server 809 on a shared burden basis.

Therefore in summary at least one embodiment can comprise means for generating information on the at least one sensory space apparatus distribution for controlling the capture apparatus in the sensory space.

In other words the capture timing controller 303 is configured to receive indications of whether any audio capture apparatus is the only audio capture apparatus operating in an audio space. As described herein, in some embodiments, the audio capture controller 203 can be configured to receive control generated by the capture timing controller 303 and control the audio signal encoder 201 to operate in an audio capture mode.

Therefore in summary at least one embodiment can comprise means for determining a capture control parameter dependent on a sensory space apparatus distribution.

For example in some embodiments, the capture timing controller 303 can be configured to pass control signals to audio capture apparatus in a shared audio space such that the capture timing controller 303 directly controls when the audio capture apparatus records or captures the audio source.

For example, the shared audio space 91 shown in FIG. 1a can be considered comprise a first audio capture apparatus 19a and a second audio capture apparatus 19b. The capture timing controller 303 can, in some embodiments on determining that both the first and second audio capture apparatus operate within a shared audio space, be configured to control the first audio capture apparatus 19a to capture audio signals for a first part or first clip and to control the second audio capture apparatus 19b to capture audio signals for a second part or second clip of an time period. In such embodiments, the clip or part time period can be partially discontinuous and non-overlapping such that the first audio capture apparatus 19a is only required to capture audio signals for part of a whole time frame period.

The audio capture apparatus audio signals and other information in some embodiments can be passed between audio capture apparatus using various communication networks as described herein such as wireless ad-hoc networks, wireless infrastructure networks, and wireless proximity networks. In some embodiments a wireless ad-hoc network can be dedicated for information related to the shared capture operations. In other embodiments, a peer-to-peer overlay network can be formed for the information related to the shared capture operations where the overlay network shares the same data channels with the other types of data. In some further embodiments, broadcast messages over wireless networks can be used where any devices in the range of the wireless network receive the message.

The means for determining the sensory space apparatus distribution information can in such embodiments comprise means for determining whether there is at least one apparatus configurable to capture at least one event in the at least one sensory space.

The operation of generating control information to allocate capture timings to audio capture apparatus within the same audio space is shown in FIG. 6 by step 505. The generation of control signal information in FIG. 6 step 507 shows where there is only a single audio capture apparatus within the audio space.

In some embodiments timing control can be performed in a distributed manner. In such embodiments the audio space determiner 301 and capture timing controller functionality can be performed in the audio capture controller 203 of each audio capture apparatus.

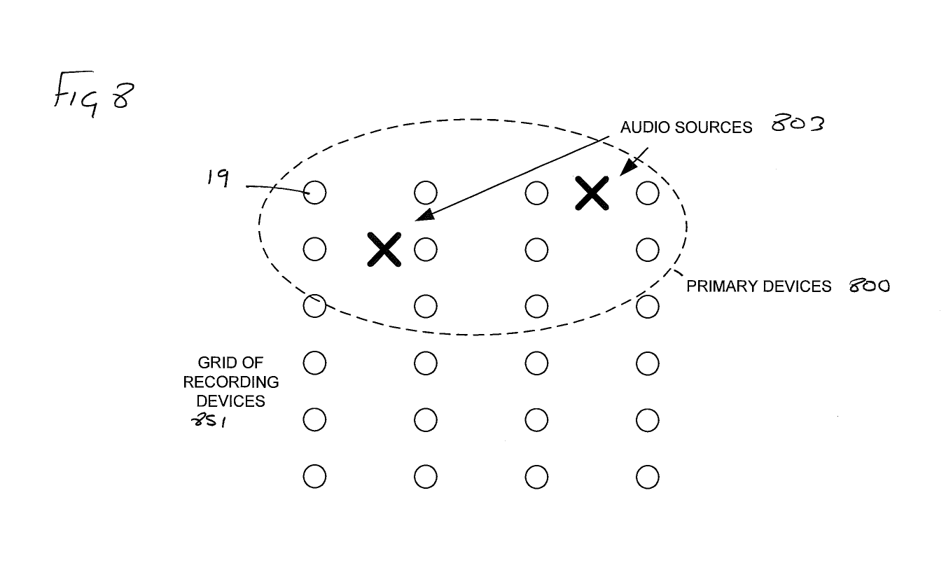

An example of the distributed control operation can be shown as described above with regards to FIG. 7. FIG. 7 shows a time division multiplex timing chart of a number of devices within a sensory space. The first audio capture apparatus 19a (device#1), the second audio capture apparatus 19b (device#2), and nth audio captured apparatus 19n (device#n) are located within the same shared audio space. In this example, device#1, the first audio capture apparatus 19a, is configured to capture the audio space shown by the recording signal being high 701, at a determined time the first audio capture apparatus 19a generates and outputs a token, message, or request 703 to other apparatus within the shared audio space. The second audio capture apparatus 19b, device#2 receives the request and captures or records the audio space, shown by the recording signal going high 705. The second audio capture apparatus 19b furthermore is configured to pass an acknowledgement message (ACK) 707 back to the first audio capture apparatus 19a which is received by the first audio capture apparatus 19a which pauses capturing the audio space.

The second audio capture apparatus 19b in some embodiments as shown in FIG. 7 can also at a determined time generate and broadcasts a further request 709 to at least one other audio capture apparatus in the shared space. In some embodiments the message can be broadcast to all other audio capture apparatus and operates a first to acknowledge system whereby after receiving a first acknowledge message the remainder of the acknowledgement messages are bounced back to the originator of the message to inform them to pause recording. In some other embodiments the message or request is broadcast using a determined pattern, for example a rota list pattern where requests are passed from one audio capture apparatus to another on the list until all audio capture apparatus in the shared audio space have captured the audio space.

In this example, the nth audio capture apparatus 19n (device#n) receives the request 709, starts audio space capture shown by the recording indicator 713 and passes an acknowledgement 711 back to the second audio capture apparatus 19b which pauses audio space capture.

Similarly the nth audio capture apparatus 19n as shown in FIG. 7 also at a determined time generates and broadcasts a further request 715 to at least one other audio capture apparatus in the shared space. In this example the request 715 is received by the first audio capture apparatus 19a which starts audio capture of the audio space 719 and passes an acknowledgement (ACK) 717 back to the nth audio capture apparatus which enables the nth audio capture apparatus to pause audio space capture.

Furthermore as also shown in FIG. 7 is where an audio capture apparatus which is not in the same shared audio space receives a request. In this example the xth audio capture apparatus (device#x) 19x operates in a different audio space to the shared audio space which comprises audio capture apparatus 19a to 19n. The receiving of the request from an audio capture apparatus in such embodiments causes no change in the operation of the audio capture apparatus 19x. The xth audio capture apparatus thus in this example continues to record or perform audio capture on the audio space comprising the xth audio capture apparatus.

In some embodiments, the capture timing controller 303 can pass to the audio capture apparatus operating within the shared audio space an indicator indicating the identity of the audio space and the number of audio capture apparatus operating within the shared audio space. A predetermined time slice allocation algorithm within each audio capture apparatus in the shared audio space can then be used to determine which part of a time frame any audio capture apparatus is to operate in an audio capture mode. In some embodiments, the capture timing controller 303 can be configured to pass a “seed value” which is used in the audio capture apparatus to determine the operation of the audio capture mode or recording. The seed value can in some embodiments be based on the identification number of the device such as the media access control address (MAC) or the international mobile equipment identity (IMEI) code, or and information on the other audio capture apparatus operating in the same shared audio space.

As shown in the timing diagram shown in FIG. 7 and described also herein in some embodiments the recording or audio capture task shared between audio capture apparatus produces an overlap period (in other words there is more than one audio capture apparatus recording simultaneously in a shared audio space so that the audio capture apparatus releasing the task should not stop audio capture or recording before the other audio capture apparatus has started the process). The overlapping time period can in some embodiments be used to further confirm that the audio content captured by the audio capture apparatus is from the same audio space. For example in some embodiments the overlapping signals can be passed to a correlator to determine the cross correlation product.

In such embodiments where the audio space determiner determines that there is a difference in the content or the audio characteristics and content such that reverberation time, signal level, direction of arrival are not sufficiently similar the switch operation for one device to another can be disabled. In some embodiments the server centrally coordinates the timing of the switch operation.

The operation of receiving at the audio capture apparatus the timing controller information (control signals) is shown in FIG. 5 by step 407.

The operation of furthermore controlling or modifying the encoding/capturing operation is shown in FIG. 5 by step 409.

Therefore in summary at least one embodiment can comprise means for capturing a signal based on the capture control parameter.

In some embodiments the audio capture apparatus 19 or the audio scene server 809 can be configured to receive the audio capture data or recorded data in real time and analyse the content to control the timing of the audio capture or recording task sharing. For example, in some embodiments, when performing audio capture on a shared audio space or recording audio content the audio scene server 809 can generate timing control messages during pauses in the uploaded audio content before switching between capture apparatus. For example, the audio scene server 809 in some embodiments can comprise a voice activity detector which indicates when voice activity decreases before controlling an audio capture apparatus switch. In such embodiments the output clip produced can be smoother as the audio capture apparatus switching is carried out during silent or stationary background noise period.

In some embodiments the practice of passing a “recording token” can be implemented as a message or a notification through a local broadcast channel, through a multicast group, or as a unicast package, for example, using a proximity network such as a Bluetooth network. The determination of the order of the audio capture apparatus operating in the determined token chain can be centralised by capture timing controller 303 or at least partially decentralised or distributed using a predetermined token chain determination algorithm. The token chain determination algorithm can in some embodiments be based on the proximity of the audio capture apparatus to the audio source or primary audio source. In some other embodiments, the order of the audio capture apparatus within the chain can be determined based on the order in which the audio capture apparatus has been notified to the joining of the shared audio space through the local broadcast channel, through the multicast group or the unicast package to devices in the proximity. In some embodiments, the token chain determination algorithm can be based on the seed value. The determination of the allocation of the time slices to the particular audio capture apparatus can be in some embodiments be predetermined or proactive or in some embodiments be reactive.

In some ‘proactive’ determination embodiments, each audio capture apparatus can be configured to be assigned time slices such that when all of the audio capture events or recordings are combined there is no gap in the combined signals. In some ‘reactive’ embodiments, the time slices can be assigned to the audio capture apparatus and be adjusted based on the success of the combined signals. For example, in a ‘reactive’ or adaptive embodiments the initial distribution should be that the signals are captured or recorded by at least one audio capture apparatus at any time. In some embodiments, the allocation of time slices to particular audio capture apparatus can be dynamic. In other words as audio capture apparatus can enter or leave the shared audio space the allocation scheme of the time slices can be adjusted accordingly.

In some embodiments, the passing of the recording token to further audio capture apparatus can be synchronous or asynchronous. For example, in some embodiments, the synchronisation can be determined on a clock source or clock signal. The synchronisation in some embodiments needs not be particularly accurate and be based on broadcasting of time synchronisation indicators over a local broadcast channel, sending time stamps over a multicast group or sending time stamps over an unicast channel to all devices in a proximity network. The origin of the time stamp in some embodiments, can be implemented using the audio scene server 809 or any of the audio capture apparatus 19.

Furthermore in some embodiments, the capture timing controller 303 (or similar implementing means) controls the audio capture apparatus, using a priority list. In other words the audio capture apparatus controls the process to select the audio capture apparatus with a higher priority with a greater frequency than an audio capture apparatus with a lower priority. For example in some embodiments the capture timing controller 303 orders the list such that the audio capture apparatus closest to the sound/data source has a higher capture priority so to try to ensure the highest quality of the downmix signal.

The distance of an audio capture apparatus to the content source can for example be determined where the source location is known. However, in some embodiments the source location relative to the audio captive apparatus is not known and a relative distance from the source can be determined by comparing the sound level differences during an ‘overlapping’ period. The audio capture apparatus producing the highest level signal in some embodiments can be determined to be the closest to the source. In some further embodiments, the audio capture apparatus can be configured to perform multi-channel audio capture and determine the direction of arrival of the sound source. In such embodiments the source location can be determined using audio triangulation.

In some further embodiments the priority list can be ordered (or the distribution of timing of the audio capture can be configured) based on power or battery consumption. For example, in some embodiments the control signals can prioritise the audio capture apparatus closed to the audio source initially and when determining that the audio capture apparatus close to the source is likely to run out of battery power allocate more time slots to audio capture apparatus further away from the audio source.

Thus in some embodiments the audio capture apparatus in a shared audio space gracefully degrade the performance without lowering battery resources instantly.

In some embodiments the priority list can be ordered based on the performance of the audio capture apparatus. For example audio capture apparatus can in some embodiments differ significantly in hardware (microphone construction) and software (codec) quality. In such examples high quality audio capture apparatus can be preferred and thus be assigned higher priority on the list of audio capture apparatus in the shared audio space.

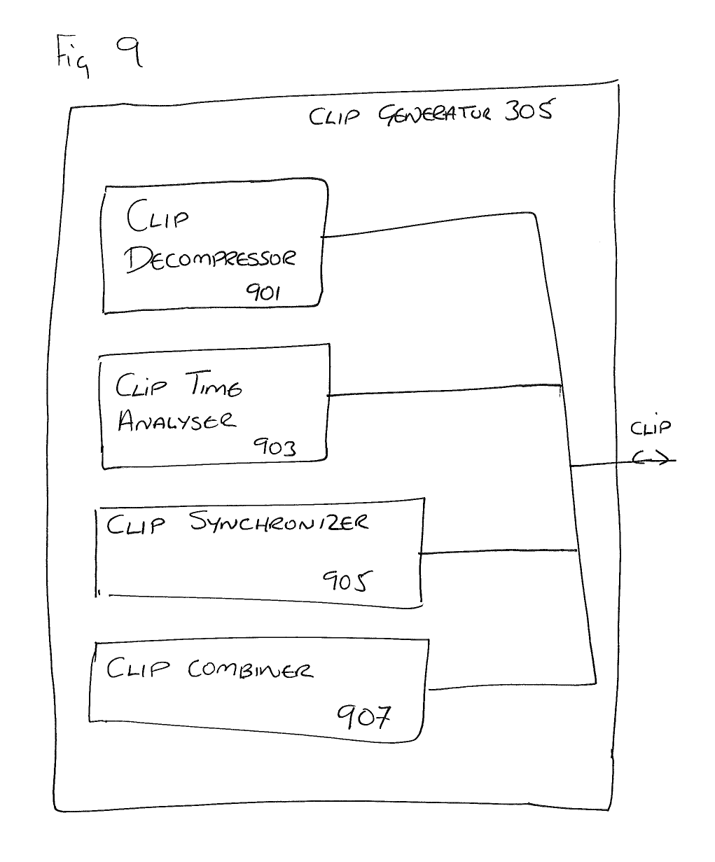

FIG. 8 shows for example a grid of recording devices 851 (audio capture apparatus) within which a pair of audio sources 803 are shown. The capture timing controller 303 can in some embodiments allocate the audio capture apparatus high priority apparatus 800 as they are neighbouring the audio sources. In such embodiments these high priority audio capture apparatus can be selected for the shared capture task with a higher frequency than the other audio capture apparatus.

In some embodiments the capture timing controller 303 can control other factors than timing multiplexing. For example in some embodiment the capture timing controller 303 can perform spectral allocation or task sharing as well as time sharing. In such embodiments the shared audio space is recorded or captured using more than one audio capture apparatus such that a first audio capture apparatus captures a first frequency range and a further audio capture apparatus can be controlled to capture a further frequency range. In such embodiments a lower sampling frequency for each audio capture apparatus conducting the recording can be used. For example, the sampling rate can be dropped in a recording phase with more than one audio capture apparatus to save computational, storage and data transmission resources within the network. The content from more than one device can then be combined by demultiplexing the stream from different audio capture apparatus and interpolating higher frequency sampling rate signals. For example, the paper “Quantisation and compensation of sample interleaved multi-channel systems” by Shay Maymon and Alan V Oppenheim in IEEE ICASSP 14 to 19 Mar. 2010 describes how individual sensors or audio capture apparatus can supply sampling below Nyquist frequencies and how the reconstruction of the high sampling rate signal can be implemented.

Although the above example as shown where the audio capture apparatus uploads the audio time slices to the audio scene server in some embodiments it would be understood that the audio capture apparatus can store the information or audio samples temporarily and upload the audio signals when (the battery of) the device is being charged so that no battery power is consumed when the audio signals are being uploaded. Furthermore in some embodiments rather than uploading the audio signal to an audio scene server 809 the audio time slices can be shared using to a peer to peer network which carries out the composition of recorded time slices and possible operations of several simultaneous recordings.

In some embodiments, such as shown in FIG. 4, the audio scene server can comprise a clip generator 305 which is configured to receive the audio capture signals for each of the shared audio spaces and is configured to combine them to produce an audio signal representative of the shared audio space.

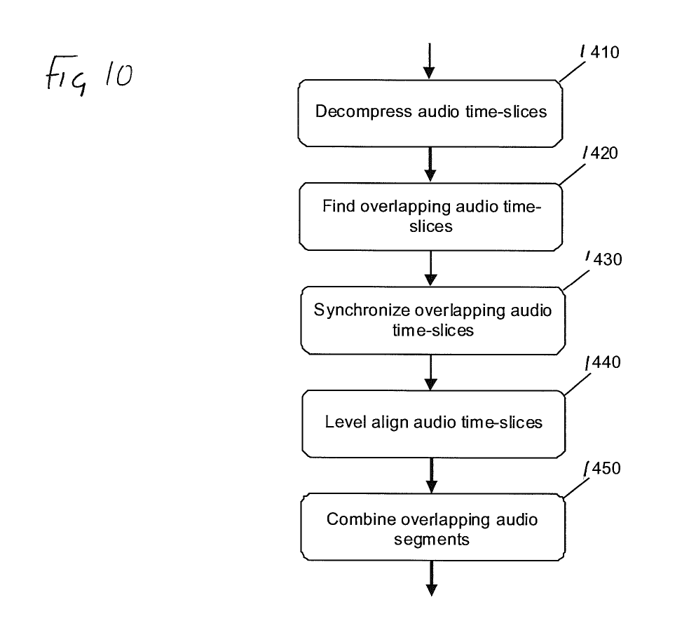

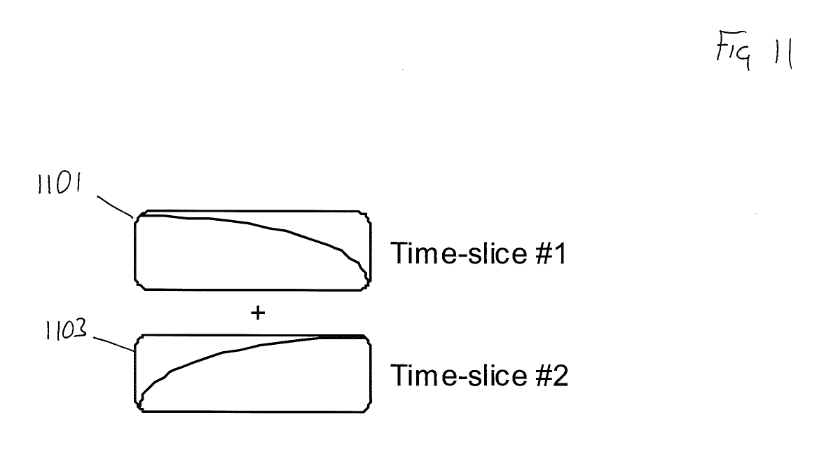

With respect to FIG. 9 and FIG. 10 the structure and the operation of the clip generator 305 is shown in further detail according to some embodiments.

The clip generator 305 having received the audio capture events, time slices or recording fragments from each of the audio capture apparatus in the shared audio space decompress each of the audio capture events in order to obtain a signal representation in the time domain. In some embodiments the clip generator 305 comprises a clip decompressor 901 configured to decompress the audio time slices and coupled to a clip time analyser 903.

The decoding of the audio capture events is shown in FIG. 10 by step 1410.

The clip generator 305 then can be configured to identify overlapping audio time slices. In some embodiments the clip generator 305 can be configured to identify the overlapping time slices from the known distribution control algorithm. In some other embodiments the clip generator 305 can be configured to cross correlate the overlapping time slices to determine common or correlating time slices.

The overlapping audio time-slices can in some embodiments be identified by searching for metadata information attached to each recorded audio time-slice. The metadata information in some embodiments can be for example identification information (such as device ID, phone number, etc) that uniquely identifies the time-slice within the sensory space.

For example using FIG. 7 the first audio capture apparatus (Device #1) is about to release the recording task and sends the request message to the second audio capture apparatus (Device #2) to indicate it wants to stop the recording task. The request message can in such example comprise the ID of first audio capture apparatus (Device #1). When the second audio capture apparatus (Device #2) receives the request message, the second audio capture apparatus saves the ID of the first audio capture apparatus (Device #1), starts the audio scene recording, and sends back an acknowledge message back to the first audio capture apparatus (Device #1) to indicate it has started a recording task. When the first audio capture apparatus (Device #1) receives the acknowledge message it stops the recording task (either immediately or after some time to guarantee a reasonable overlap between the time-slices). The recorded audio time-slice of the first audio capture apparatus (Device #1) is then attached the metadata information that includes the ID of the first audio capture apparatus (Device #1). When the second audio capture apparatus (Device #2) is about to release the recording task the same steps as described herein can be carried out switching the recording between the first audio capture apparatus (Device #1) and the second audio capture apparatus (Device #2) can be repeated between the second audio capture apparatus (Device #2) and the nth audio capture apparatus (Device #n). The request message in this example now includes the ID of the second audio capture apparatus (Device #2). When the second audio capture apparatus (Device #2) receives the acknowledge message the second audio capture apparatus stops the recording task. The recorded audio time-slice is then attached the metadata information that includes the ID of the first audio capture apparatus (Device #1) and the second audio capture apparatus (Device #2). The ID of the audio capture apparatus (Device #1) can be used to identify the time-slice which is overlapping with the start of the time-slice of the second audio capture apparatus (Device #2). The metadata information in such examples therefore can comprise the following elements

ID of the audio capture apparatus/recorder
ID of the overlapping audio capture apparatus/recorder

In addition, the metadata information could in some embodiments comprise a time stamp corresponding to the beginning and the end of the time slice the audio capture apparatus is recording.

Time stamp on the beginning of the time-slice
Time stamp on the end of the time-slice

Time stamps can in some embodiments be applied to determine the length of the individual time-slice and finding overlapping time-slices.

Using the same example, the metadata for the second audio capture apparatus (Device #2) in such examples can be

ID of the audio capture apparatus/recorder: ID of Device #2
ID of the overlapping audio capture apparatus/recorder: ID of Device #1
Time stamp1: Clock of device #2 when starting the recording
Time stamp2: Clock of device #2 when ending the recording

The overlapping audio time-slices for time-slice ‘s’ in the shared audio space could in some embodiments be identified by searching for all the remaining time-slices whose “ID of the overlapping audio capture apparatus/recorder” field matches the “ID of the audio capture apparatus/recorder” field in time-slice ‘s’.

The overlapping time of two independent time-slices can in some embodiments be determined using the time stamp information. However, it should be noted that, the absolute time stamp values of different devices are not necessarily synchronized to any global timing. In such circumstances, time stamps cannot be used for aligning the different time-slices as such. Only once the time stamps of each audio capture apparatus in the shared audio space is synchronized by comparing the ID information from overlapping audio capture apparatus and determining the detailed time differences of the overlapping time-slices can the information be used for finding overlapping time-slices.

In some embodiments as described herein several audio capture apparatus within the shared audio space receive the request message and therefore send the corresponding acknowledge message. In such embodiments delays in the networking between the audio capture apparatus can cause the audio capture apparatus receiving the acknowledge message to stop the recording task before all the acknowledge messages have been received by the audio capture apparatus (as it may not know how many remote audio capture apparatus received the request message in the first place). In these cases some of the overlapping audio time-slices may actually not overlap creating false results in the identification of overlapping time-slices and subsequently may result in perceptual distortions in the reconstructed continuous signal. Therefore in some embodiments the audio capture apparatus ID can be inserted into the acknowledge message. This ID can in such embodiments be included in the metadata as follows

ID of the audio capture apparatus/recorder
ID of the overlapping audio capture apparatus/recorder
ID #1 of the overlapping audio capture apparatus/recorder (ACK)
ID #2 of the overlapping audio capture apparatus/recorder (ACK)
. . .
ID #N of the overlapping audio capture apparatus/recorder (ACK)

In such embodiments the initial search for overlapping audio time-slices would be similar to that described above. In addition in such embodiments after all relevant overlapping time-slices for time-slice s have been found, another search would take place where those time-slices that are not present in the “ID #X of the overlapping recorder (ACK)” field of time-slice s would be excluded because overlapping between the time-slices is not guaranteed.

The determination of overlapping audio time-slices is shown in FIG. 10 by step 1420.

Furthermore in some embodiments the clip generator 305 can be configured to time align the overlapping audio time-slices. In some embodiments this time alignment value can be determined from the known distribution control algorithm. In some embodiments the clip generator 305 correlation operation further can be used to determine any time alignment between the overlapping time slices.

In some embodiments the identified time-slices with respect to time-slice ‘s’ can be time aligned to achieve synchronized time stamping between the recorded audio time-slices. The time alignment can be implemented as follows

time_align(s,s_{fi}), 0≦i<N
where N is the number of overlapping time-slices found for time-slice s, and sf are the overlapping audio time-slices. The time_align( ) is a function that time aligns the input signals. In some embodiments the alignment process implemented can be similar to that shown by using a Fourier transform as presented in “G. C. Carter, A. H. Nutall, and P. G. Cable, “The smoothed coherence transform,” Proceedings of the IEEE, vol. 61, no. 10, pp. 1497-1498, 973”, using AMDF (average magnitude difference function) as presented in “R. Cusani, “Performance of fast time delay estimators,” IEEE Trans. Acoustics, Speech, and Signal Processing, vol. 37, no. 5, pp. 757-759, 1989” or a combination of AMDF and cross-correlation as presented in “Chen, J, Benesty, J and Huang, Y, “Performance of GCC and AMDF Based Time Delay Estimation in Practical Reverberant Environments” Journal on Applied Signal Processing, vol. 1 pp. 25-36, 2005”

In some such embodiments the clip generator 305 can comprise a time analyser 903 configured to receive the decompressed audio time slices and compare them to identify the overlapping time slices.

The results of the time analyser 903 can be passed to the clip synchronizer 905. The clip synchronizer 905 can be configured on receiving the results from the time analyser 903 further perform alignment of the time slices.

The operation of time alignment of the identified time slices is shown in FIG. 10 by step 1030

Furthermore in some embodiments the clip generator 305 is configured to level align the overlapping audio time-slices. Level alignment in some embodiments can be amplitude level alignment, frequency response alignment or a combination of both.

As the amplitude capture levels in the overlapping audio time-slices are not known the amplitude alignment attempts to prevent any sudden jump in the volume levels and perceptual disruptions that might occur in the audio signal when switching from one audio time-slice to another.

For example in some embodiments the clip synchronizer 905 can further perform amplitude alignment.

In some further embodiments the time analyser 903 can be configured to further determine any frequency response difference between overlapping time slices and provide this information to the clip synchronizer 905 which can be configured to filter at least one of the time slices to attempt to reduce any perceived ‘colour’ changes between time slices.

The level alignment can therefore in some embodiments be based on, for example, level aligning the time-slices in root mean square (RMS) sense according to

$${rms}_{i} = \sqrt{\frac{{\sum }_{j = 0}^{T - 1} {t}_{j}^{2}}{T}} , 0 \leq i < T$$

$$rms\_ref = mean ( rms )$$

$${rms\_coef}_{i} = \frac{rms\_ref}{{rms}_{i}} , 0 \leq i < T$$

$${t}_{i} = {t}_{i} \cdot {rms\_coef}_{i} , 0 \leq i < T$$

where mean( ) determines the average value of the input vector, t={t_{1,} t_{2,} . . . t_{T,}} is a vector that consists of overlapping audio time-slices that, when combined, make up a continuous signal and T is the number of time-slices to be level aligned.

Using FIG. 7 as an example, the vector could be composed as follows: t_{1,} is the first audio time-slice of Device #1, t_{2,} is the first audio time-slice of Device #2, t_{3,} is the first audio time-slice of Device #N, t_{4,} is the second audio time-slice of Device #1, and finally, t_{5,} is the second audio time-slice of Device #2.

The level alignment may be applied over the entire vector, only to neighbouring time-slices, for example, to t_{1,} and t_{2,}, or to a limited set of neighbouring time-slices, for example, from t_{1,} to t_{3,}. Furthermore, the level alignment may be applied either to a time domain representation of the vector or to a frequency domain representation of the vector.

Other level alignment methods can in some embodiments further comprise dynamic range control (DRC) methods such as described in “A modular signal processor for digital filtering and dynamic range control of high quality audio signals; McNally, G.; Moore, T.; Acoustics, Speech, and Signal Processing, IEEE International Conference on ICASSP '81. Volume: 6 Publication Year: 1981, Page(s): 590-594” and “Audio dynamic range control for set-top box; KyuSik Chang; ChunHo Yi; TaeYong Kim; Consumer Electronics, 2009. ICCE '09. Digest of Technical Papers International Conference on Digital Object Identifier: 10.1109/ICCE.2009.5012397 Publication Year: 2009, Page(s): 1-2”.

The operation of level alignment is shown in FIG. 10 by step 1040.

In some embodiments the clip generator 305 can comprise a clip combiner 907 configured to receive the processed time slices from the output of the clip synchronizer 905 to generate a suitable output clip of audio capture from the shared audio space.

Any suitable combination operation or algorithm can be employed by the clip combiner 907. As shown in FIG. 11 a pair of filters are shown which can be used on the pre and post time slices to attempt to produce a combined time slice with a limited discontinuity. The first filter 1101 with a decreasing profile can for example be applied to the first time slice which decreases the first time slice composition in the combined time slice and the second filter 1103 with an increasing profile can be applied to the second time slice which increases the second time slice composition in the combination as time progresses.

In some other embodiments the clip combiner can implement averaging or weighted averaging between the samples in the overlapping segment. If more than one overlapping segment is found, the same steps can be implemented in some embodiments of the application. If the time-slices recorded by two or more audio capture apparatus are overlapping, a multi-channel downmix of the signal data may be derived from the various time slices. The location of the observer (within the shared audio space) and the direction or distribution of the channels required to be generated can be supplied to the clip combiner in order that a suitable clip can be generated.

The operation of combining the processes time slices is shown in FIG. 10 by step 1450.

The delivery of the combined signal to the listening device as described herein can be implemented by various means.

In some embodiments the combined signal can be compressed using any suitable data compression method.

The combined signal can then in some embodiments be transmitted through the same data channel used to upload/upstream the recorded time-slices or a different data channel may be used. For example, a unicast uplink connection to a audio scene server can be used for upstreaming the audio capture events (the recorded time-slices), whereas a local wireless broadcast can be used to downstream the combined signal.

The combined signal can in some embodiments be downloaded or streamed to the listening device. In some embodiments where the combined signal is downloaded, the data can be arranged in such a manner that progressive downloading is possible, in other words, the listening device can decode and play the signal while the file is being received. For example, the file may be arranged according to the Progressive Download profile of the 3GPP file format.

The time delay of recording time-slices and receiving the respective part of the combined signal can vary in different implementations. In some embodiments an implementation can demonstrate a short time delay between audio capture and combined clip received at the listening device providing a live, or close to real-time reproduction of the continuous signal. In some other embodiments the receiving of the clip can be performed after the recording event has been completed.

In some embodiments it can be configured that the audio scene server allows the reception of data in an interactive manner. In other words the listening device can control the generation of the output combined time slices, for example by selecting the audio capture apparatus used or selecting an observation position and direction within the shared audio space.

Although the above has described the audio and shared audio space it would be understood that similar embodiments can implement a visual or audio-visual space sharing operation.

It would be appreciated that embodiments of the application would enable lower power consumption for applications such as ‘life logging’, a new type of service which enables the recording of public events such as lectures or crowded places. Providing the battery or power consumption of such an operation is low enough, users could leave the feature always on and where there are a high enough density of other apparatus, audio recording or capture can be automatically started in the background and automatically uploaded to a service. The service can then in some embodiments be integrated to a map/streetview/webcam service offering near-real-time live audio feeds in addition to any visual feed.

In such embodiments, the processing and battery life of such devices can be extended over devices which have to continuously record or capture the audio scene.

It shall be appreciated that the term user equipment is intended to cover any suitable type of wireless user equipment, such as mobile telephones, portable data processing devices or portable web browsers.

Furthermore elements of a public land mobile network (PLMN) may also comprise apparatus as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. Apparatus comprising at least one processor and at least one memory including computer code, the at least one memory and the computer code configured to with the at least one processor cause the apparatus to at least:
generate a message comprising a first part for determining a sensory space associated with the apparatus, wherein the message first part comprises at least one of: a captured audio signal; an estimated location of the apparatus; and an estimated direction of the apparatus;
determine a capture control parameter dependent on a sensory space apparatus distribution; and
capture a signal based on the capture control parameter.

2. (canceled)

3. The apparatus as claimed in claim 1, wherein the capture control parameter comprises at least one of:
a capture time period;
a capture frequency range; and
a capture direction.

4. The apparatus as claimed in claim 1, further caused to determine the sensory space apparatus distribution by determining whether at least one further apparatus is associated with the sensory space associated with the apparatus.

5. (canceled)

6. The apparatus as claimed in claim 4, further caused to receive a further message comprising a first part for determining a sensory space associated with the at least one further apparatus.

7. The apparatus as claimed in claim 1, further caused to:
output the signal based on the capture control parameter; and
output the message comprising the first part for determining a sensory space associated with the apparatus to a further apparatus.

8. (canceled)

9. The apparatus as claimed in claim 1, further caused to receive the sensory space apparatus distribution from a further apparatus in response to outputting the message comprising the first part for determining a sensory space associated with the apparatus to a further apparatus.

10. (canceled)

11. An apparatus comprising at least one processor and at least one memory including computer code, the at least one memory and the computer code configured to with the at least one processor cause the apparatus to at least:
determine, for at least one sensory space, a sensory space apparatus distribution information by determining whether there is at least one apparatus configurable to capture at least one event in the at least one sensory space; and
generate information on the at least one sensory space apparatus distribution for controlling the capture apparatus in the sensory space.

12. (canceled)

13. The apparatus as claimed in claim 11, further caused to output the information for controlling the capture apparatus in the sensory space to at least one capture apparatus in the sensory space.

14. The apparatus as claimed in claim 11, wherein the information for controlling the capture apparatus is at least one of:
time division multiplexing information;
spatial division multiplexing information; and
frequency division multiplexing information.

15. The apparatus as claimed in claim 11, further caused to:
combine at least two capture signal clips to produce a combined capture signal by filtering each capture signal clip and combining each filtered capture signal clip; and
receive at least one capture clip from a further apparatus.

16. (canceled)

17. (canceled)

18. The apparatus as claimed in claim 11, wherein the information for controlling the capture apparatus in the sensory space comprises a capture handover request.

19. The apparatus as claimed in claim 11, wherein the apparatus caused to determine, for at least one sensory space, a sensory space apparatus distribution information further causes the apparatus to:
determine whether at least one further apparatus is associated with the at least one sensory space.

20. The apparatus as claimed in claim 19, wherein the apparatus caused to determine whether at least one further apparatus is associated with the at least one sensory space further causes the apparatus to:
receive at least one further apparatus message comprising a first part for determining a sensory space associated with the apparatus; and
determine whether at least one further apparatus is associated with the at least one sensory space based on the at least one further apparatus message.

21. A method comprising:
generating a message comprising a first part for determining a sensory space associated with the apparatus, wherein the message first part comprises at least one of: a captured audio signal; an estimated location of the apparatus; and an estimated direction of the apparatus;
determining a capture control parameter dependent on a sensory space apparatus distribution; and
capturing a signal based on the capture control parameter.

22. (canceled)

23. The method as claimed in claim 21, wherein the capture control parameter comprises at least one of:
a capture time period;
a capture frequency range; and
a capture direction.

24. The method as claimed in claim 21, further comprising determining the sensory space apparatus distribution by determining whether at least one further apparatus is associated with the sensory space associated with the apparatus.

25. (canceled)

26. The method as claimed in claim 24, further comprising receiving a further message comprising a first part for determining a sensory space associated with the at least one further apparatus.

27. The method as claimed in claim 21, further comprising:
outputting the signal based on the capture control parameter; and
outputting the message comprising the first part for determining a sensory space associated with the apparatus to a further apparatus.

28. (canceled)

29. The method as claimed in claim 21, further comprising receiving the sensory space apparatus distribution from a further apparatus in response to outputting the message comprising the first part for determining a sensory space associated with the apparatus to a further apparatus.

30. (canceled)

31. A method comprising:
determining, for at least one sensory space, a sensory space apparatus distribution information by determining whether there is at least one apparatus configurable to capture at least one event in the at least one sensory space; and
generating information on the at least one sensory space apparatus distribution for controlling the capture apparatus in the sensory space.

32. (canceled)

33. The method as claimed in claim 31, further comprising outputting the information for controlling the capture apparatus in the sensory space to at least one capture apparatus in the sensory space.

34. The method as claimed in claim 31, wherein the information for controlling the capture apparatus is at least one of:
time division multiplexing information;
spatial division multiplexing information; and
frequency division multiplexing information.

35. The method as claimed in claim 31, further comprising:
combining at least two capture signal clips to produce a combined capture signal by filtering each capture signal clip and combining each filtered capture signal clip; and
receiving at least one capture clip from a further apparatus.

36. (canceled)

37. (canceled)

38. The method as claimed in claim 31, wherein the information for controlling the capture apparatus in the sensory space comprises a capture handover request.

39. The method as claimed in claim 31, wherein determining, for at least one sensory space, a sensory space apparatus distribution information comprises determining whether at least one further apparatus is associated with the at least one sensory space.

40. The method as claimed in claim 39, wherein determining whether at least one further apparatus is associated with the at least one sensory space comprises:
receiving at least one further apparatus message comprising a first part for determining a sensory space associated with the apparatus; and
determining whether at least one further apparatus is associated with the at least one sensory space based on the at least one further apparatus message.

41. (canceled)

42. (canceled)
